(19) United States
(12) Patent Application Publication
(10) Pub. No.: US 2016/0032592 A1
(43) Pub. Date: Feb. 4, 2016

(54) EXTENDABLE RAIL SYSTEM FOR HELIPORTS

(71) Applicant: Troy Breaux, Rayne, LA (US)

(72) Inventor: Troy Breaux, Rayne, LA (US)

(21) Appl. No.: 14/450,752

(22) Filed: Aug. 4, 2014

(51) Int. Cl. E04F 11/18; B64F 1/30

(52) U.S. Cl. CPC E04F 11/1863; E04F 11/1817; B64F 1/30; E04F 2011/1868; E04F 2011/187; E04F 2011/1876

(57) ABSTRACT

An extendable rail system for a flight of stairs to exit a heliport comprising a railing positioned along the flight of stairs, where the railing includes a handrail; a plurality of anchors attached to the railing, where the plurality of anchors support the handrail; a rail extension attached to a top portion of the railing, where the rail extension moves between a first position and a second position; a motor coupled to the rail extension, where the motor moves the rail extension between the first position and the second position; a first actuator positioned on the heliport, where the first actuator activates the motor; and a second actuator positioned at a base of the railing, where the second actuator activates the motor.

### BACKGROUND OF THE INVENTION

1. Field of the Invention

The present invention relates to an extendable railing that extends and retracts along a staircase from a heliport.

2. Description of Related Art

Because of the inherent dangers when traversing a flight of stairs, the recommended way to ascend or descend is with a three point contact protocol. This typically involves grabbing a railing, or pair of railings, and taking steps one at a time. The three points of contact ensure balance and maintain safety when climbing the stairs. This way the person always has a foothold or hand grab in case they slip or miss a step.

Heliports are increasingly being used in buildings like hospitals and hotels. They are useful because they provide a safe landing platform for a helicopter in locations where the helicopter typically cannot land; like a downtown or urban area where the flat open spaces or not readily available. The heliports typically have an opening that leads to a staircase beneath the platform. Because of helicopter safety, the railing does not extend above the heliport platform. Although their availability is growing, their safety protocols are lacking While the three point protocol is the preferred method to walk safely down stairs, these new heliports do not have the proper provisions for the beginning the descent down the stairs. Many times the stairs include a railing that the person is only able to grab once they've traversed the first few stairs, therefore creating a nerve racking experience until the railing is reached.

Therefore it would be beneficial in the art to provide a railing for heliport stairs that remains beneath the heliport until needed. It would also be desirable for the railing to be easily accessible as the user approaches the stairs.

### SUMMARY OF THE INVENTION

In view of the foregoing disadvantages inherent in the prior art, the general purpose of the present invention is to provide an extendable rail system for a flight of stairs to exit a heliport, configured to include all of the advantages of the prior art, and to overcome the drawbacks inherent therein.

Accordingly, an object of the present invention is to provide an extendable rail system for a heliport, where a rail extension moves along a railing to provide a safety rail as a user initiates their descent from the heliport.

Another object of the present invention is to provide an extendable rail system with a motorized rail extension that is activated with a foot pedal positioned at the top of the stairs.

To achieve the above objects, in an aspect of the present invention, an extendable rail system for a flight of stairs is described comprising a railing positioned along the flight of stairs, where the railing includes a handrail; a plurality of anchors attached to the railing, where the plurality of anchors support the handrail; a rail extension attached to a top portion of the railing, where the rail extension moves between a first position and a second position; a motor coupled to the rail extension, where the motor moves the rail extension between the first position and the second position; a first actuator positioned on the heliport, where the first actuator activates the motor; and a second actuator positioned at a base of the railing, where the second actuator activates the motor.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of an extendable rail system for heliport in accordance with an exemplary embodiment of the present invention.

### DETAILED DESCRIPTION OF THE DRAWINGS

The present invention relates to an extendable railing that extends and retracts along a staircase from a heliport. The present invention provides an extendable rail system for heliports to offer a user a device which affords support when traversing stairs that lead to and away from the heliport. The extendable rail system includes a 32 inch handrail coupled with a motor. The motor may utilize a pedal actuator to raise and lower the handrail thereby providing a readily available balance structure to the user as they descend the steps.

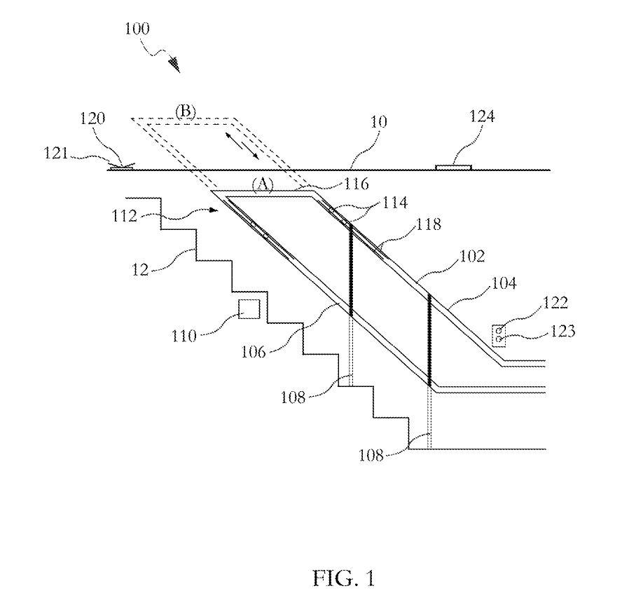

Turning now descriptively to the drawing, referring to FIG. 1, an extendable rail system 100 for a heliport 10 is shown in accordance with an exemplary embodiment of the present invention. The extendable rail system 100 includes a railing 102 with a handrail 104 and a support rail 106. The handrail 104 is positioned above the support rail 106 to provide a balance support for a user when traversing a flight of stairs 12 beneath a heliport 10. FIG. 1 illustrates a single railing 102 for simplicity, but a pair of railings may be provided with one railing on each side of the flight of stairs 12. The railing 102 is fastened to the flight of stairs 12 with a plurality of anchors 108. The anchors 108 maintain the height of the handrail 104 and support rail 106. The anchors 108 may be balusters that fasten to the flight of stairs 12. The railing 102 may be made from steel, aluminum, wood, plastic or the like materials able to withstand outdoor conditions.

The railing 102 is coupled to a motor 110 to move a rail extension 112 at an end of the railing 102. The rail extension 112 may be a U-shaped structure that connects the handrail 104 and the support rail 106 at a top end of the railing 102. The rail extension 112 may be rectangular (as shown) or curved depending on the likes and preferences of the user. At an end of the rail extension 112 is a top rail 116 to provide the top most support rail for the extendable rail system 100. The rail extension 112 moves along the railing 102 with a set of rollers 114.

The rollers 114 are coupled to the motor 110, and extend and retract the rail extension 112 once activated. The rollers 114 may move along the handrail 104 and the support rail 106 on a liner 118. The liner 118 provides structural support and stability to the railing 102 ensuring that the rail extension 112 moves smoothly.

The motor 110 may powered by an electrical source like a 12-volt battery, generator, electrical outlet or the like. With a battery or generator the motor 110 is operable even when electricity is unavailable to the heliport 10. Additionally, the motor 110 may be coupled to a solar panel 124 to recharge the internal battery thereby providing continuous power.

During use, the rail extension 112 moves from a first position (A) to a second position (B). In the first position (A), the rail extension 112 is remains level or beneath the heliport 10. In the second position (B), the rail extension 112 is elevated above the heliport 10 to raise the top rail 116 to a height convenient for a user standing on the heliport 10. The rail extension 112 may extend up to 42 inches above the heliport 10 thereby offering a comfortable grabbing height for the user to hold the top rail 116 when initiating their descent down the flight of stairs 12. By positioning the rail extension 112 beneath the heliport 10 when in the first position (A), it ensures that the extendable rail system 100 remains out of the way and does not interfere with anything on the heliport 10 until needed for traversing the flight of stairs 12. Further, the motor 110 may be activated by a first actuator 120 or a second actuator 122.

The first actuator 120 is mounted within the heliport 10 at the top of the flight of stairs 12. The first actuator 120 may be a foot pedal 121 that when pressed or stepped on extends the rail extension 112 from the first position (A) to the second position (B). Alternatively, the first actuator 120 may be motion activated, so that when the user comes within a predetermined distance from the first actuator 120 the rail extension 112 is automatically extended. The second actuator 122 is positioned at the bottom of the flight of stairs 12 towards the base of the railing 102. The second actuator 122 may include a pair of buttons 123 to move the rail extension 112. The buttons 123 direct the rail to move up or down as needed by the user. The motor 110 may also include an automatic refraction mode, which if the rail extension 112 has been in the second position (B) for a predetermined amount of time without trigger from either thee first actuator 120 or the second actuator 122 the rail extension will automatically retract. With the extendable rail system 100 the users are safe and comfortable when approaching the flight of stairs 12.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An extendable rail system for a flight of stairs to exit a heliport comprising:
a. a railing positioned along the flight of stairs, where the railing includes a handrail;
b. a plurality of anchors attached to the railing, where the plurality of anchors support the handrail;
c. a rail extension attached to a top portion of the railing, where the rail extension moves between a first position and a second position;
d. a motor coupled to the rail extension, where the motor moves the rail extension between the first position and the second position;
e. a first actuator positioned on the heliport, where the first actuator activates the motor; and
f. a second actuator positioned at a base of the railing, where the second actuator activates the motor.

2. The extendable rail system according to claim 1, where the motor includes a power source.

3. The extendable rail system according to claim 2, where the power source is a battery.

4. The extendable rail system according to claim 3, where the battery includes a solar panel.

5. The extendable rail system according to claim 2, where the battery is a 12-volt battery.

6. The extendable rail system according to claim 1, where the railing is a pair of railings, one on each side of the flight of stairs.

7. The extendable rail system according to claim 1, where the first position positions the rail extension beneath the heliport.

8. The extendable rail system according to claim 1, where the second position positions the rail extension up to 42 inches above the heliport.

9. The extendable rail system according to claim 1, where the rail extension moves with a set of rollers within the railing.

10. The extendable rail system according to claim 9, where the set of rollers move along a liner within the railing.

11. The extendable rail system according to claim 1, where the railing includes a support rail positioned beneath the handrail.

12. The extendable rail system according to claim 1, where the first actuator includes a foot pedal.

13. The extendable rail system according to claim 1, where the first actuator includes a motion sensor.

14. The extendable rail system according to claim 1, where the second actuator includes a pair of buttons.
